(19) United States
(12) Patent Application Publication
(10) Pub. No.: US 2002/0002900 A1
(43) Pub. Date: Jan. 10, 2002

(54) Drum educational entertainment apparatus

(76) Inventor: Kuk Su Cho, Suwon City (KR)

Correspondence Address: Stephen A. Bent, FOLEY & LARDNER, Washington Harbour, 3000 K Street, Suite 500, Washington, DC, 20007-5109, US

(21) Appl. No.: 09/878,921

(22) Filed: Jun. 13, 2001

(30) Foreign Application Priority Data
Jun. 13, 2000 (KR) KR10-2000-0032302
Dec. 14, 2000 (KR) KR20-2000-0034975

(51) Int. Cl. G10H 1/02

(52) U.S. Cl. 84/738

(57) ABSTRACT

The present invention relates to an educational entertainment apparatus which comprises drum instrument set. More particularly, the present invention is directed to an educational entertainment apparatus for allowing players to play drum instrument set which generates acoustic sound and for evaluation and grading the accuracy and skillfulness of drum play.

### TECHNICAL FIELD OF THE INVENTION

The present invention relates to an educational entertainment apparatus which comprises drum instrument set. More particularly, the present invention is directed to an educational entertainment apparatus for allowing players to play drum instrument set which generates acoustic sound and for evaluation and grading the accuracy and skillfulness of drum play.

### BACKGROUND ART OF THE INVENTION

The musical instrument called drum instrument set comprises a snare, base, tomtom, hihat, and cymbal. The tomtom is divided into a large tomtom and a small tomtom. Large tomtom is often referred to as a floor tomtom. Small tomtom is composed of two ones. Drum instrument set may further comprises various metallic percussion instruments called symbal, if needed. Also, traditional Korean drums, so called “buk”, Japanese or Chinese folk drums may be added to the composition of the drum instrument set.

All kinds of drum mentioned in above and metallic percussion instrument, irrespective of both the East and the West genre of drums, can be employed in the drum instrument set of the present invention.

At present, an electronic drum game apparatus emulating drum play are commercialized in video game arcade. These electronic drum game apparatus is composed of monitors, foot pedals emulating bass drum play and hit spots imitating drum and cymbals, instead of using actual acoustic drums and cymbals. Players of this game apparatus can emulate the drummer's motion by stepping on the pedals or hitting the hit spots thereby, and enjoy the electric sounds generated from the above electronic game apparatus.

In the above electronic drum game apparatus, a player hits the designated hit spots with the stick according to the visual signal represented in the monitor, and emulates the motion of drum play. Consequently, the drum game apparatus only produces electric sounds according to signal which is made by hitting the hit spots.

Due to these aspects, the drum game apparatus commercialized only serves as an electronic game apparatus for entertainment without the function as a musically educational entertainment apparatus. That is, it had rather negative effect on the musical education since the sound generated from the electronic drum game apparatus is electronically synthesized sound, thus these game apparatus were never served as an entertainment apparatus for musical education.

The hit spots which imitates of the electronic drum game apparatus are not actual acoustic drums. Thus, it cause rather a negative effect on the emotional peace(equilibrium). The emotional peace (equilibrium) was generated by beautiful harmonious sounds, beats, and rhythm which is the essence of musical education. However, the computer-synthesized sounds generated from the said game apparatus has no educational effect on players.

In addition, the operation technique of the electronic drum game apparatus differ greatly from that of actual drum instrument set and thereby, even though a person who get mastery of the operation of electronic drum game apparatus would not become an experts in play of actual acoustic drum.

Therefore, no effect on musical education can be expected from the electronic drum game apparatus and consequently, it can not function as educational entertainment apparatus, which is new trend of the latest market for entertainment apparatus throughout the world.

Also, the object of electronic drum game entertainment apparatus is not musically aspirated, but only for recreational purposes. In electronic drum game apparatus, the beat which are not used in actual drum play, are usually employed in order to adjust the degree of the difficulty of game, thus, it can not contribute to musical education.

Furthermore, the technique of operation of electronic drum game apparatus require minimal amount of physical motions, whereas the actual acoustic drums require forceful and repetitive strikes which needed strenuous physical strength. Consequently, the electronic drum game apparatus which needs minimal physical exercise, has little effect on the physical health of players.

In order to overcome the above problem of the electronic drum game apparatus, the inventor of the present invention has developed a drum educational entertainment apparatus which comprises a soundproof enclosed space wherein actual acoustic drums and metallic percussion instruments were installed. The drum educational entertainment apparatus of the present invention enable the player to evaluate the accuracy of drum play and to enhance the skill of drum play.

Therefore, the object of the present invention is to provide a drum educational entertainment apparatus for allowing the player to enjoy the actual acoustic sounds and for evaluating skills of drum play for him/herself by computer. Furthermore, the drum educational entertainment apparatus of the present invention is to allow the player to feel the accomplishment of playing, and to provide the player with the beneficial effect on musical education through the play of the drum educational entertainment apparatus.

### SUMMARY OF THE INVENTION

Therefore, the object of the present invention is to provide an apparatus of drum educational entertainment apparatus, which comprises:

a box which forms enclosed space;

an entrance door of said box;

an accounting unit for accounting coin or paper currency insert thereto;

a drum instrument set which is integrated into one body and fixed on the floor of said box;

a control box which is equipped within the said enclosed space and controls operation of the present apparatus through electric signals;

a monitor which develops visual signals forwarded from said control box;

a speaker which develops the sound signals forwarded from the control box.

The present invention may further comprises a sound sensor for detecting the sound signals generated from the said drum instrument set and forwarding the signals thus collected to the control box.

### BRIEF DESCRIPTION OF THE DRAWINGS

The above objects and other advantages of the present invention will become more apparent by describing in detail a preferred embodiment thereof with reference to the attached drawings, in which:

FIG. 1 is the perspective view of the drum educational entertainment apparatus of the present invention.

### DETAILED DESCRIPTION OF THE INVENTION

Hereinafter, an apparatus of the present invention will be described in detail with reference to the accompanying drawings. However, the drum educational entertainment apparatus explained in below is given only for the explanation of the embodiment of the present invention and not intended to limit the scope of the present invention.

The drum educational entertainment apparatus of the present invention which comprises:

a box 1 which forms enclosed space;

an entrance door 2 of said box 1;

an accounting unit 3 for accounting coin or paper currency insert thereto;

a drum instrument set 4 which is integrated into one body and fixed on the floor of said box 1;

a control box 5 which is equipped within the said enclosed space and controls operation of the present apparatus through electric signals;

a monitor 8 which develops visual signals forwarded from said control box;

a speaker 9 which develops the sound signals forwarded from the control box 5.

Preferably, the present invention may further comprises a sound sensor 7 for detecting the sound signals generated from the said drum instrument set and forwarding the signals thus collected to the control box.

In the drum educational entertainment apparatus of the present invention, sound sensor 7 can be mounted to the drum and/or cymbal, or on the control box and when necessary, the sound sensor may be placed anywhere within the interior of the enclosed box.

An accounting unit 3 for inserting coin or paper currency need not be placed on the entrance door nor on the control box, but it can be placed anywhere within the interior of the enclosed box.

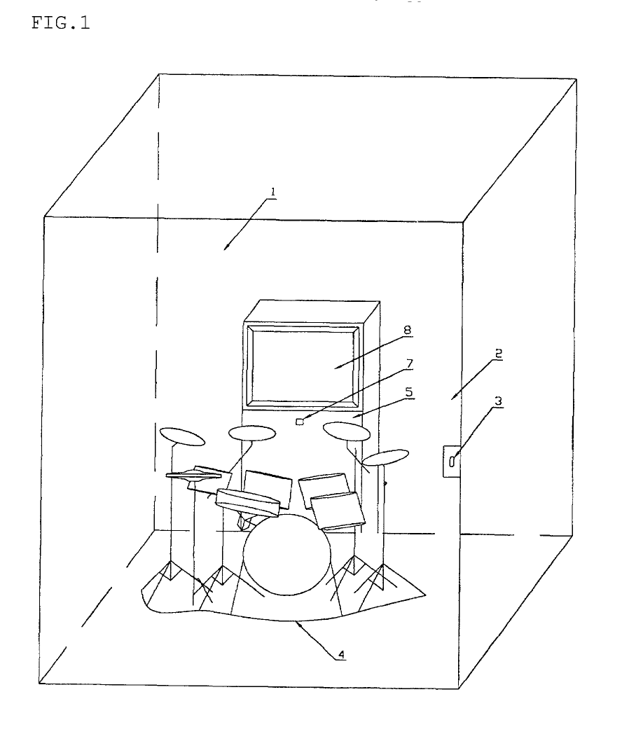

FIG. 1 is the perspective view of the drum educational entertainment apparatus of the present invention.

As illustrated in FIG. 1, the apparatus of the present invention comprises a box 1 which forms enclosed space, the entrance door 2 formed on the box, drum instrument set 4 which is integrated into one body and fixed on the floor of said box 1, the control box 5 which regulate the operation of this apparatus under the control of program which is divided into various steps according to degree of difficulty, and regulate forwarding the results of grading, various melodies and visual signals into the monitor, the sound sensor 7 which detects sound generated by the player's hitting, a monitor 8 which develops the scores, music melodies, and visual signals which are developed and forwarded from the control box 5, and an accounting unit 3 for inserting coin, which placed either on the entrance door 2 or the control box 5 in order to control the on/off of the entrance door and the power supply of the control box.

Therefore, the drum educational entertainment apparatus of the present invention comprises a box, an entrance door, drum set, control box, monitor, speaker and an accounting unit.

The box which forms enclosed space in the drum educational entertainment apparatus, is soundproof regular hexahedron, perfect hexahedron, cylindrical, conical(cone) and et al. Shape of the box does not matter, however, the space thereof ought to be large enough to install a drum instrument set, a control box and a monitor.

Therefore, the internal volume of the drum educational entertainment apparatus of the present invention, is 1M³ to 20M³, and regardless of the shape of the box, the minimum floor area is 0.5M² to 10M², and the box should be large enough for the forming of an entrance door.

The external shape of the box which forms the enclosed space of the present invention, may be in form of various kinds of animals or house form, cars or airplane form, or drum instruments form for considering the visual enjoyment of user and usage thereof as an entertainment. The external shape of the box that forms the soundproof enclosed space of the present invention is not a essential part of the drum educational entertainment apparatus. In consideration of the esthetic taste of user, a person skilled in the art, may change the shape appropriately.

Regardless of neither shape nor the different possible functions of entrance door of the present invention, whether the shape is rectangular, square, or cylindrical, or the functions be sliding way, cover way, junction way, the dimension ought to be at minimum 0.2M², enough for a person to pass through.

The drum instrument set may be installed in the said enclosed space, generally comprises Korean traditional drum, buk, a changku, a gong, cymbal, tambourine, timpani, western drums and et al., various types of wooden and metallic percussion instruments. Therefore, the drum instrument set employed in the present invention, comprises various types of percussion instruments such as big drums, small drums, various types of drums and cymbal, metallic tub, wooden tub, and wooden drums of which can generate sound by beating or scratching.

The control box of the present invention functions to gather sound signals from sound sensors continuously, allows the player to know whether he/she is playing the drums accurately in accordance with the visual signals illustrated on the monitor.

The control box of the present invention comprises three kinds of memory set. The first memory set stores music scores which are divided into tens of different levels according to the degree of difficulty. The second memory set stores the sounds through the speakers and the melodic signals with background images while drum set is being played. The third memory set stores visual signal and audio signal to educate the player the skill of drum play through monitor and/or speaker for one(1) to ten(10) minutes. The control box of the present invention comprises the central processing unit wherein the computer program which controls and adjusts the function of control box, is installed.

The conventional singing machine, so called “KARAOCHE” instrument can be employed as the control box of the present invention, if necessary. A person skilled in the art can operate the control box to adjust, the melody sound's octave, tone, and beat. Therefore, the said control box of the “KARAOCHE Room” can be used as the control box of the present invention.

The drum educational entertainment apparatus of present invention may optionally comprises the sound sensor that is selectively chosen from the conventional sound sensors for gathering signals to be used in grading the player's skill and for forwarding the date to the central processing unit of the control box.

An accounting unit of the present invention may be mounted on the entrance door or the control box. It controls the entrance door and the power supply of the control box. The accounting unit of the present invention is alike that of the general video arcade machine. It is connected to the entrance, the interior lighting inside the drum room, and the power switch of the control box and the monitor, therefore controlling the start or end of operation.

The accounting unit of the present invention is composed of a slot for inserting money and paper currency, change slot. It functions as a calculator and storage of received money. The money insert unit of the present invention functions alike that of the general money inserts, therefore, may be used as the component of the present invention.

### Industrial Applicability

The drum educational entertainment apparatus of the present invention is a musical educational entertainment apparatus using the actual acoustic drum.

The apparatus of the present invention allow the player to enjoy acoustic sound by playing the actual drum instrument set and to evaluate the skill of drum play for him/herself. Therefore, the apparatus of the present invention function as the musical education apparatus, along with entertainment function.

In addition, the drum educational entertainment apparatus of the present invention have a good role for reducing the body weight and stress level due to the fierce playing work of drum instrument set.

While the present invention has been particularly shown and described with reference to particular embodiment thereof, it will be understood by those skilled in the art that various changes in form and details may be effected therein without departing from the spirit and scope of the invention as defined by the appended claims.

What is claimed is:

1. A drum educational entertainment apparatus of the present invention, which comprises:
a box which forms enclosed space;
an entrance door of said box ;
an accounting unit for accounting coin or paper currency insert thereto;
a drum instrument set which is integrated into one body and fixed on the floor of the box;
a control box which is equipped within the said enclosed space and controls operation of the present apparatus through electric signals;
a monitor which develops visual signals forwarded from said control box;
a speaker which develops the sound signals forwarded from the control box.

2. The drum educational entertainment apparatus according to claim 1, wherein internal volume of the box is 1M³ to 20M³ and minimum floor area of the box is 0.5M² to 10M².

3. The drum educational entertainment apparatus according to claim 1, further comprising a sound sensor for detecting the sound signals generated from the said drum instrument set and forwarding signals to the control box.
